(19) United States
(12) Patent Application Publication
(10) Pub. No.: US 2022/0063998 A1
(43) Pub. Date: Mar. 3, 2022

(54) MICRONIZED SULPHUR POWDER

(71) Applicant: SULVARIS INC., Calgary (CA)

(72) Inventors: Robert MACKIE, Calgary, AB (CA); Bri SEBASTIAN, Calgary, AB (CA); Mitchel FLEGEL, Calgary, AB (CA)

(21) Appl. No.: 17/418,180

(22) PCT Filed: Dec. 23, 2019
(86) PCT No.: PCT/CA2019/051904

§ 371 Date: Jun. 24, 2021

Related U.S. Application Data
(60) Provisional application No. 62/786,134, filed on Dec. 28, 2018.

(51) Int. Cl. C01B 17/10; C05D 9/00; C05C 1/02; C05C 3/00; C05B 13/00

(52) U.S. Cl. CPC C01B 17/10; C05D 9/00; C01P 2004/60; C05C 3/005; C05B 13/00; C05C 1/02

(57) ABSTRACT

A process is provided to produce a micronized sulphur powder product, including the preparation of a micronized sulphur emulsion from molten sulphur and a dispersant solution, including a surfactant in a concentration less than the critical micelle concentration of the surfactant.

### FIELD OF THE INVENTION

This invention relates to a process for processing elemental sulphur into micronized particles.

### BACKGROUND

Elemental sulphur is an essential ingredient in several industrial applications including crop fertilizer applications, ammunition manufacture, and rubber vulcanization.

One complication with the use of particulate elemental sulphur in fertilizer applications in the prior art is that when applied to soil in the form of particles greater than 100 micron size, the sulphur is very slow in reaching the roots of plants. Sulphur in its elemental form is insoluble in water and hence cannot be absorbed by the roots of plants. It is converted by microbial action into water soluble sulphate which is subsequently readily absorbed by plant roots.

Direct application of water soluble sulphate fertilizers is possible, but uptake suffers from over dissolution, as well as uncontrolled release and leaching, thereby leading to poor returns on farm input investment.

Conversion of particulate elemental sulphur into sulphate-sulphur is considerably more effective when the particles are small, particularly at a particle size less than about 30 microns, a size range commonly referred to as micronized sulphur. When applied to soil where plants are grown, micronized sulphur can provide the plants with nutrients in the same season of application, and as such, micronized sulphur has value and application in the fertilizer industry.

There is also application for the use of micronized sulphur in ammunition manufacturing, since finely divided sulphur particles combust with greater efficiency and effectiveness in comparison to large sulphur particles. Use of a consistent, finely sized micronized sulphur particle in ammunition manufacture would likely result in the manufacture of a higher quality and more reliable ammunition.

The automobile and aviation rubber manufacturing industry also require large quantities of fine sulphur powder for vulcanization of rubber. The reaction between sulphur and rubber results in very hard and durable material with physical properties that can be maintained over a comparatively wide range of temperature. Thus, the finer the sulphur powder the better would be the reaction with rubber, and the higher would be the quality of rubber produced. Fine sulphur is also widely used in the latex industry as vulcanization agent to provide strength to the products. Finer sulphur particles reduces the curing time and provides better tensile strength to product like the latex gloves, mattresses etc.

In other applications, the paint industry also uses very fine sulphur powder as a color blend. Micronized sulphur is also widely used as a fungicide, insecticide and pesticide, and in addition, has medicinal uses for treating skin ailments in humans.

Micronized sulphur powder may be produced by pulverizing sulphur lumps in mechanical milling equipment. Conventional milling results are dependent upon substantial energy consumption, particularly in circumstances where very finely sized particles are acquired. Additionally, milling technologies for production of micronized sulphur powder pose fire and explosion hazards. Sulphur is a flammable and explosive substance, and by its nature, mechanical milling can result in risk exposure to explosion.

Therefore, there is a need in the art for alternative methods of producing micronized sulphur particles.

### SUMMARY OF THE INVENTION

In one aspect, the invention comprises a method of producing micronized sulphur, comprising the steps of:

(a) preparing an emulsion of liquid sulphur in an aqueous dispersant solution comprising a surfactant in a concentration below its critical micelle concentration (CMC); and

(b) solidifying the liquid sulphur droplets to produce a micronized sulphur suspension.

In some embodiments, the quantity of surfactant can be optimized by measuring the CMC in the solution and determining an optimum concentration of surfactant which minimizes particle size and/or particle size variation. The CMC of the surfactant may be measured by measuring its surface tension using standard techniques and equipment known to those skilled in the art. Preferably, the concentration of surfactant is less than about 75%, 50%, 40%, 30% or 20% of its CMC.

The surfactant may comprise an anionic surfactant or a nonionic surfactant, such as naphthalene sulphonate or octylphenol ethoxylate.

In preferred embodiments, the surfactant concentration is less than about 0.75% (wt.).

In another aspect, the invention may comprise a micronized sulphur product, where the mean or median particle size is about 5 microns or less, or preferably about 3 microns of less. In another aspect, the invention may comprise a micronized sulphur product where 95% of the particles are less than about 12, 10, 9 or 8 microns in size.

In another aspect, the invention may comprise a micronized sulphur powder product, dispersed in solution comprising an aqueous dispersant comprising a surfactant in a concentration below 1.5% (wt.) and below its critical micelle concentration (CMC). In preferred embodiments, the mean or median particle size is less than about 5 microns in size, or less than about 3 microns in size, and the mean or median particle size does not substantially increase over 24 hours, 2, 3, 4, 5, 6 , 7 or 30 days of storage.

Preferably, the average particle size of the particles within the 50^{th}, 60^{th}, 70^{th}, 80^{th}, 90^{th} or 95^{th} percentile does not substantially increase over time.

In some embodiments, the product may further comprise a fertilizer salt, such as urea ammonium nitrate (UAN), ammonium sulphate, ammonium polyphosphate (APP), and/or a herbicide, pesticide or fungicide.

In some embodiments, the product is a liquid suspension and further comprises a suspension agent, such as a polysaccharide, such as a substituted or unsubstituted starch, pectate, alginate, carageenate, gum arabic, guar gum and xanthan gum, or a clay.

In preferred embodiments, the suspension does not comprise any solubilized sulphur.

### BRIEF DESCRIPTION OF THE DRAWINGS

FIG. 1. The average mean percentile PSD (P50, μm) of 100 Hz micronized sulphur dispersion produced with various water sources over time (hours).

FIG. 2. The average lower percentile PSD (P10, μm) of 100 Hz micronized sulphur dispersion produced with various concentrations of Morwet™ over time (days) in demineralized water.

FIG. 3. The average mean percentile PSD (P50, μm) of 100 Hz micronized sulphur dispersion produced with various concentrations of Morwet™ over time (days) in demineralized water.

FIG. 4. The average upper percentile PSD (P95, μm) of 100 Hz micronized sulphur dispersion produced with various concentrations of Morwet™ over time (days) in demineralized water.

FIG. 5. The average mean percentile PSD (P50, μm) of 100 Hz micronized sulphur dispersion produced with various concentrations of Morwet™ over time (days) in demineralized water where all Morwet concentrations were increased to 5% at day 4.

FIG. 6. The average mean percentile PSD (P50, μm) of 100 Hz micronized sulphur dispersion produced with various concentrations of Morwet™ in demineralized water where all 5% Morwet samples from FIG. 5 were heated to 80 C.

FIG. 7. The 10^{th}, 20^{th}, 30^{th}, 40^{th}, 50^{th}, 60^{th}, 70^{th}, 80^{th}, 90^{th}, and 95^{th} particle size percentiles (μm) of 100 Hz micronized sulphur dispersion produced with 1% Morwet™ over time (hours) in demineralized water.

FIG. 8. The 10^{th}, 20^{th}, 30^{th}, 40^{th}, 50^{th}, 60^{th}, 70^{th}, 80^{th}, 90^{th}, and 95^{th} particle size percentiles (μm) of 100 Hz micronized sulphur dispersion produced with 1% Morwet™ over time (hours) in tap water.

FIG. 9. The 10^{th}, 20^{th}, 30^{th}, 40^{th}, 50^{th}, 60^{th}, 70^{th}, 80^{th}, 90^{th}, and 95^{th} particle size percentiles (μm) of 100 Hz micronized sulphur dispersion produced with 1.25% Morwet™ over time (hours) in demineralized water.

FIG. 10. The 10^{th}, 20^{th}, 30^{th}, 40^{th}, 50^{th}, 60^{th}, 70^{th}, 80^{th}, 90^{th}, and 95^{th} particle size percentiles (μm) of 100 Hz micronized sulphur dispersion produced with 1.5% Morwet™ over time (hours) in demineralized water.

FIG. 11. The 10^{th}, 20^{th}, 30^{th}, 40^{th}, 50^{th}, 60^{th}, 70^{th}, 80^{th}, 90^{th}, and 95^{th} particle size percentiles (μm) of 100 Hz micronized sulphur dispersion produced with 1.5% Morwet™ over time (hours) in tap water.

FIG. 12. The 10^{th}, 20^{th}, 30^{th}, 40^{th}, 50^{th}, 60^{th}, 70^{th}, 80^{th}, 90^{th}, and 95^{th} particle size percentiles (μm) of 100 Hz micronized sulphur dispersion produced with 2% Morwet™ over time (hours) in demineralized water.

FIG. 13. The 10^{th}, 20^{th}, 30^{th}, 40^{th}, 50^{th}, 60^{th}, 70^{th}, 80^{th}, 90^{th}, and 95^{th} particle size percentiles (μm) of 100 Hz micronized sulphur dispersion produced with 2% Morwet™ over time (hours) in tap water.

FIG. 14. The 10^{th}, 20^{th}, 30^{th}, 40^{th}, 50^{th}, 60^{th}, 70^{th}, 80^{th}, 90^{th}, and 95^{th} particle size percentiles (μm) of 100 Hz micronized sulphur dispersion produced with 3% Morwet™ over time (hours) in demineralized water.

FIG. 15. The 10^{th}, 20^{th}, 30^{th}, 40^{th}, 50^{th}, 60^{th}, 70^{th}, 80^{th}, 90^{th}, and 95^{th} particle size percentiles (μm) of 100 Hz micronized sulphur dispersion produced with 3% Morwet™ over time (hours) in tap water

FIG. 16. The 10^{th}, 20^{th}, 30^{th}, 40^{th}, 50^{th}, 60^{th}, 70^{th}, 80^{th}, 90^{th}, and 95^{th} particle size percentiles (μm) of 100 Hz micronized sulphur dispersion produced with 5% Morwet™ over time (hours) in demineralized water.

FIG. 17. The 10^{th}, 20^{th}, 30^{th}, 40^{th}, 50^{th}, 60^{th}, 70^{th}, 80^{th}, 90^{th}, and 95^{th} particle size percentiles (μm) of 100 Hz micronized sulphur dispersion produced with 5% Morwet™ over time (hours) in tap water

FIG. 18. The average mean percentile PSD (P50, μm) of 100 Hz micronized sulphur dispersion that has been stirred or left undisturbed (settled) over time (days), without additional surfactant added.

FIG. 19 shows the average mean percentile PSD (P50, μm) for those samples where additional Morwet™ was added at Day 4 to the treatments for a total of 5.0%.

FIG. 20. The 10^{th}, 20^{th}, 30^{th}, 40^{th}, 50^{th}, 60^{th}, 70^{th}, 80^{th}, 90^{th}, and 95^{th} particle size percentiles (μm) of 100 Hz micronized sulphur dispersion produced with 1% Triton X-405 over time (hours) in ordinary tap water.

FIG. 21. The 10^{th}, 20^{th}, 30^{th}, 40^{th}, 50^{th}, 60^{th}, 70^{th}, 80^{th}, 90^{th}, and 95^{th} particle size percentiles (μm) of 100 Hz micronized sulphur dispersion produced with 1.5% Triton X-405 over time (hours) in ordinary tap water.

FIG. 22. The 10^{th}, 20^{th}, 30^{th}, 40^{th}, 50^{th}, 60^{th}, 70^{th}, 80^{th}, 90^{th}, and 95^{th} particle size percentiles (μm) of 100 Hz micronized sulphur dispersion produced with 2% Triton X-405 over time (hours) in ordinary tap water.

FIG. 23. The 10^{th}, 20^{th}, 30^{th}, 40^{th}, 50^{th}, 60^{th}, 70^{th}, 80^{th}, 90^{th}, and 95^{th} particle size percentiles (μm) of 100 Hz micronized sulphur dispersion produced with 5% Triton X-405 over time (hours) in ordinary tap water.

### DETAILED DESCRIPTION OF THE ILLUSTRATED EMBODIMENTS

As described in further detail below, the present invention comprises a method to produce a micronized sulphur product. The product is comprised of very fine sulphur particles having a mean particle diameter of between about 1 to about 7 microns. A basic method of production of micronized sulphur is described in U.S. Pat. No. 8,679,446, the entire contents of which are incorporated herein by reference, where permitted.

In some embodiments, elemental sulphur is melted, and separately a superheated water dispersant solution is produced, for subsequent blending. Molten sulphur may be produced in a heating vessel by heating lump sulphur or other sulphur feedstock to above the melting point of sulphur. This generally requires heating to a temperature of about 115° to 150° C. The specific equipment which can be used to produce molten sulphur will be well known understood to those skilled in the art, using adjusted process parameters, which will accomplish the objective of allowing for the melting and pumping of sulphur.

The dispersant may be an anionic, cationic, amphoteric, or non-ionic surfactant, or combinations thereof. The surfactant stabilizes the emulsion of liquid molten sulphur in the dispersant solution during the homogenization process. In some embodiments, the surfactant comprises an anionic surfactant such as napthalene sulfonate (such as Morwet™), or carboxymethyl cellulose. Suitable anionic surfactants include, but are not limited to, lignin derivatives such as lignosulphonates, aromatic sulphonates and aliphatic sulphonates and their formaldehyde condensates and derivatives, fatty acids/carboxylates, sulphonated fatty acids and phosphate esters of alkylphenol-, polyalkyleryl- or alkyl-alkoxylates. Suitable cationic surfactants include, but are not limited to, nitrogen-containing cationic surfactants.

Alternatively, the surfactant may comprise a nonionic surfactant such as an alkylphenol ethoxylate (e.g. octylphenol ethoxylate (Triton™ X-405)). In one embodiment, the dispersant comprises a non-ionic surfactant. Suitable non-ionic surfactants for use in the present invention include alkoxylated fatty alcohols, alkoxylated fatty acids, alkoxylated fatty ethers, alkoxylated fatty amides, alcohol ethoxylates, nonylphenol exthoxylates, octylphonel ethoxylates, ethoxylated seed oils, ethoxylated mineral oils, alkoxylated alkyl phenols, ethoxylated glycerides, castor oil ethoxylates, and mixtures thereof.

Although the use of a surfactant as a dispersant is known in the art, modifying the concentration of the surfactant has been found to have unexpected effect. The concentration of surfactant in the dispersant solution is reported as a wt % in the dispersant solution and is controlled to be below the critical micelle concentration (CMC), which will vary according to the surfactant and numerous other parameters, including the water source, salt concentration of the solution and temperature. In preferred embodiments, the concentration of the surfactant is less than about 75%, 50%, 40%, 30%, 20% or 10% of the CMC.

The CMC of a surfactant in solution may be quantified by empirically measuring surface tension using a tensiometer, as is well-known in the art. The CMC is determined as the point where the baseline of minimal surface tension and the slope where surface tension shows linear decline intersect. Surface tension versus log concentration may be plotted by measuring a series of manually mixed solutions or using commercially available automated equipment.

In some embodiments, the dispersant solution is formed with demineralized water. Demineralized water may be produced by a variety of different methods, including distillation, reverse osmosis, ultrafiltration, deionization with ion-exchange resins, or any other method of purifying water. As used herein, “demineralized water” is water which is substantially free of dissolved ions, regardless of how it is produced. One method of measuring the purity of demineralized water is by a conductivity test, or conversely, a resistivity test. Demineralized water suitable for this invention will have a conductivity less than about 100 μS/cm at 20° C., and preferably less than about 5.0 μS/cm, and more preferably less than about 2.0 μS/cm. In alternative embodiments, the dispersant solution is formed with tap water, well water, or any available source of water which may have dissolved ions.

The dispersant solution is superheated under pressure to a temperature in a range from about 115° C. to about 150° C. In practice, a pressure vessel capable of operating in the range from about 25 to about 80 psig, is effective to permit heating of a substantially aqueous dispersant solution to a temperature of between about 115° C. to about 150° C., while substantially maintaining the dispersant solution in liquid form.

The molten sulphur and the heated dispersant solution may then be blended in a homogenizer to produce an emulsified sulphur suspension. Any suitable homogenization equipment using mechanical means or fluid shear means are possible. For example, in one embodiment, a fast-rotating mechanical disc type homogenizer or a high pressure nozzle atomization type of emulsification equipment may be used. The result of this step will be the emulsification of molten sulphur into a micronized dispersed phase, within the dispersant solution, yielding emulsified sulphur emulsion. By varying the speed of the blending apparatus, the spacing of the serrations in the mechanical discs, or the size/pressure of the atomizer spray, the process can be optimized to produce particles of a certain average size, or of a certain maximum or minimum size.

Following discharge from the emulsification or homogenization equipment, the emulsified sulphur emulsion may then be cooled by any suitable means. For example, the emulsion may be cooled in a heat exchanger or other similar equipment, by flashing the emulsion to a lower pressure, or be simply allowed to cool to below the melting point of sulphur. Preferably, the emulsified sulphur suspension is cooled to below 100° C. for further processing. On cooling, the finely dispersed molten sulphur droplets in the emulsion will solidify, forming micron sized solid sulphur particles.

Without restriction to a theory, it is believed that the concentration of the surfactant has surprising and unexpected effects on the particle size of the solidified sulphur particles. Generally, when surfactants are dispersed in aqueous solution, they can either adsorb at a hydrophobic/hydrophilic interface or self-assemble in bulk solution. Adsorption is defined as the concentration of surfactants at the interface, while self-assembly is the aggregation of surfactants into micelles.

In the process of micronizing sulphur described above, the surfactant functions, at least in part, to decrease the interfacial tension between the generally insoluble molten sulfur and the water phase. The driving force for surfactant adsorption is the lowering of free energy of the phase boundary. As such, surfactant molecules will preferentially assemble at the interface until the concentration reaches a point where the energy required to keep a surfactant molecule at the surface is no longer favorable. At this point, surfactants begin to form micelles in solution, and is the definition of the critical micelle concentration.

Elemental sulfur has very little solubility in pure water. However, in the presence of surfactants, the solubility of sulphur increases significantly. With increasing surfactant concentration, the formation of micelles, and the increase in the amount of solubilized sulfur increases. It is believed that the smallest particles are the quickest to dissolve. To decrease the overall energy of the system, solubilized sulphur is then deposited on other particles upon the suspension cooling, leading to particle growth and crystallization. Therefore, if the surfactant concentration is increased past the CMC during the homogenization process, it is believed that more particle growth will be observed upon cooling.

CMC is affected by several parameters. Temperature, ionic strength, ion type, and surfactant type are all important factors. In the case of an ionic surfactant, CMC decreases in the presence of ions. The fully ionized head groups result in a significant amount of electrostatic repulsion between head groups, hindering the formation of micelles. However, due to the high electric field strength of these head groups, cations are quickly adsorbed. This adsorption decreases the electrostatic repulsion between the headgroups (via shielding) and enhances the stability of micelles at lower CMCs.

CMC may be increased by adding substances such as urea and formamide. These are known to compensate for the deleterious effects of high salt concentrations. The addition of chaotropic agents, such as an alcohol, have been found to decrease CMC. CMC effects are also influenced by chaotrope concentration; generally a greater concentration of the chaotrope will result in a decreased CMC. Conversely, anti-chaotropic agents or kosmotropes, such as ammonium sulphate, may increase CMC.

Applicant has discovered that reducing the surfactant concentration can result in smaller, more uniform micronized sulphur particles, in the average range of 1 to 5 microns. In Applicant's prior work, micronized sulphur particles in the average range of 7 microns were reliably produced, using a naphthalene sulfonate surfactant in the range of 1.5% (wt.) in the dispersant solution and ordinary tap water. It is believed this is the result of limiting sulphur solubility during homogenization and reducing particle size growth after solidification. Therefore, in preferred embodiments, the dispersant solution is made up to a surfactant concentration well below its CMC, but still sufficient to reduce the interfacial tension between the liquid sulphur and water to permit the micronized emulsion to form. In practice, this may be less than about 75%, 50%, 40%, 30%, 20% or 10% of the CMC.

The process water used to make up the solution may vary in hardness, pH and conductivity depending on the facility water source. The ionic strength and ion type has a significant effect on how the surfactant performs. Consequently, in some embodiments, it is preferred to determine how the process water affects the chosen surfactant, and subsequently the physical characteristics, primarily, the size of the sulfur particles. In some embodiments, the method comprises testing the dispersant solution to determine the CMC of the chosen surfactant.

For example, the particle size of the sulphur particles was seen to increase over time when tap water, which contains ions, is used as the water source in the homogenization process as compared to using demineralized water. The CMC for ionic surfactants in tap water is likely below about 2-3% wt. concentration of surfactant. Above this concentration, the particle size can and does increase after production.

The resulting suspension of micronized sulphur may be stored for significant periods of time, for later incorporation into fertilizer products in granular or liquid forms. The small amount of surfactant (below the CMC value) likely stabilizes the suspension, without causing any significant solubilization of the sulphur.

Thus, a suspension of micronized sulphur where the mean or median particle size is about 5 microns or smaller in size, or preferably about 3 microns or smaller, may be stable in storage. As used herein, a “stable” suspension is one where the average particle size does not substantially increase over at least 24 hours, 2, 3, 4, 5, 6 , 7 or 30 days. In some embodiments, a preferred stable suspension is one where the average particle size of particles smaller than the P50, P60, P70, P80, P90 or P95th percentile of the particle size distribution does not substantially increase over time. A particle size is considered not to substantially increase if any particle size growth is less than 50%, 40%, 30%, 20%, or 10% of the original size.

The micronized sulphur suspension may be blended with other fertilizer salts, such as urea ammonium nitrate (UAN), ammonium sulphate, ammonium polyphosphate (APP), or other salts, or various herbicides, pesticides or fungicides to produce combination fertilizer products, without risk of significant particle size growth over periods of 1 week to 1 month or longer. If a liquid fertilizer is desired, a suspension agent may also be added, such as a polysaccharide, for example substituted starches, pectates, alginates, carrageenates, gum arabic, guar gum and xanthan gum, or a clay.

In some embodiments, it is preferred to periodically stir or agitate the micronized sulphur suspension, as this appears to delay the dissolution and deposition of dissolved sulphur onto the particles to increase the particle size. Constant or periodic agitation may work to delay or eliminate particle size increases after production.

Alternatively, the suspension can be processed to yield micronized sulphur cake or powder. This can be accomplished using readily available equipment to recover or remove the dispersant solution from the emulsified sulphur suspension, such as a filtering device such as a mechanical filter, decanter or centrifuge. The finely dispersed micronized sulphur particles, created during the emulsification process, are thus separated from the dispersant solution.

The adding of additional surfactant to the micronized sulphur dispersion after production does not seem to affect the particle size of the micronized sulphur, therefore, in some embodiments, additional surfactant may be used to increase the stability of the dispersion for storage.

The addition of various salts, such as a 1%-5% brine solution, a 1%-5% ammonium sulfate solution, or a 1%-5% UAN solution, after the production of micronized sulphur does not appear to affect the average particle size when using an ionic surfactant (e.g. Morwet™) or non-ionic (e.g. Triton X-405) below about 5% surfactant in the dispersant solution.

### EXAMPLES

The following examples are provided to illustrate embodiments of the invention and are not intended to limit the claimed invention in any way.

### Example 1—Particle Size Distribution

Particle size distributions were determined for micronized sulphur dispersions made with different water sources.
1. Micronized sulphur dispersion+1.5% Morwet™ (wt.%)+demineralized water
2. Micronized sulphur dispersion+1.5% Morwet™ (wt.%)+tap water

For each treatment, micronized sulphur dispersion was produced with 1.5% Morwet™ D-425 and either demineralized or Calgary tap water (˜448 μS/cm). A sample of the mixture was collected at the output of the homogenizer pilot plant and the particle size distribution (PSD) was tracked for 24 hours using a Microtrac instrument. Each PSD measurement was done in triplicate and the PSD is shown as the value of particle diameter at 50% in the cumulative distribution (PSD D50).

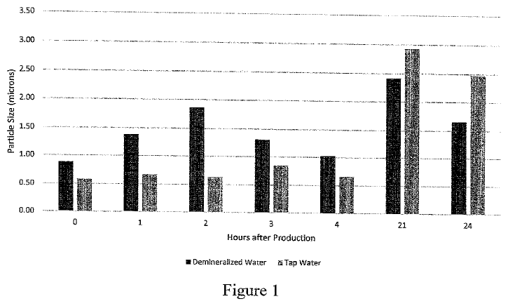

The PSD data (FIG. 1) shows that particle sizes were relatively consistent for the first 4 hours of monitoring. Particle sizes then increased for both the demineralized water and tap water samples, over the course of 24 hrs. The tap water sample grew larger in size than the demineralized sample, suggesting that the dissolved ions in tap water lowers the CMC of Morwet™. This drop in CMC results in the dissolution of sulphur during the homogenization process and the subsequent deposition of dissolved sulphur on existing particles upon cooling, causing a slight increase in size.

### Example 2: Methods for the CMC of Micronized Sulphur Dispersion at Various Morwet™ Concentrations

The micronized sulphur dispersions that were tested and monitored were as follows:

| Surfactant Concentration (wt | |
|---|---|
| % Morwet ™) in dispersant | |
| solution | Water Type |
| 0.5% | demineralized |
| 0.75% | demineralized |
| 1% | demineralized |
| 1.5% | demineralized |
| 3.0% | demineralized |

Fresh micronized sulphur dispersion was produced at 100 Hz (homogenization tip speed) with demineralized water at sulphur concentrations of approximately 60% sulphur and was immediately collected and tested for PSD after production. Samples were further tested daily until particle size plateaued. Once the PSD plateaued, additional Morwet™ was added to the samples to bring the total Morwet™ concentration to 5%. The PSD was tracked daily until PSD plateaued.

Twenty mL samples with 5% Morwet™ concentration were transferred to a hot plate and were heated to 80° C. for 2 minutes. PSD was tested immediately after heating.

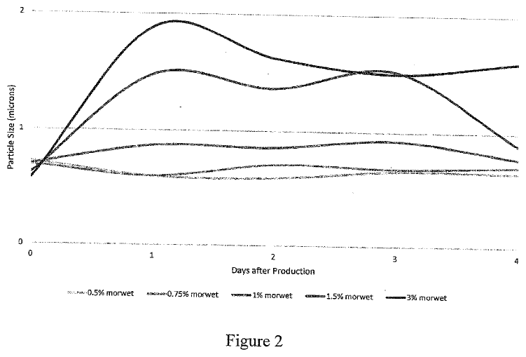

FIG. 2 shows the average lower percentile PSD (P10, μm) of 100 Hz micronized sulphur dispersion produced with various concentrations of Morwet™ over time (days) before additional surfactant is added. The micronized sulphur dispersion material was produced with fresh micronized sulphur dispersion and demineralized water.

FIG. 2 shows a particle size increase in samples with 1.5% and 3% Morwet™ after Day 1 from approximately 0.5 microns to 1.5 microns. The particle sizes of sample containing less than 1.5% Morwet™ did not change significantly in size and remained below 0.7 microns, suggesting that the smallest of the particles did not increase in size.

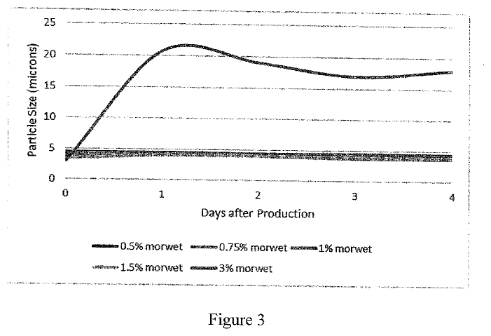

FIG. 3 shows the average mean percentile PSD (P50, μm) of 100 Hz micronized sulphur dispersion produced with various concentrations of Morwet™ over time (days) before the additional surfactant is added. The micronized sulphur dispersion material was produced with fresh micronized sulphur dispersion and demineralized water.

FIG. 3 shows particle size under 5 microns for samples containing less than 3% Morwet™ and particle sizes of 20 microns with 3% Morwet™. This data suggests that the CMC, which causes significant sulphur dissolution and particle growth, lies between 1.5% and 3% Morwet™ concentration during the homogenization process, in demineralized water.

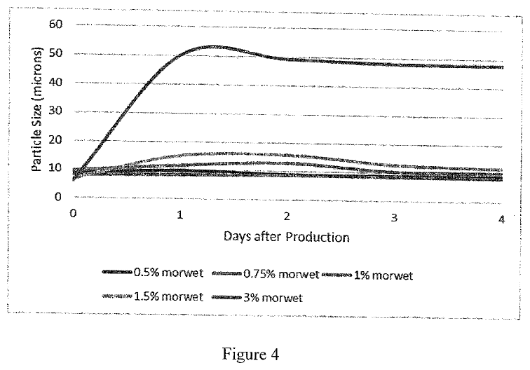

FIG. 4 shows the average upper percentile PSD (P95, μm) of 100 Hz micronized sulphur dispersion produced with various concentrations of Morwet™ over time (days) before the additional surfactant is added. The micronized sulphur dispersion material was produced with fresh micronized sulphur dispersion and demineralized water.

As seen in FIG. 4, significant particle growth occurred for Morwet™ concentrations above 1.5% during the homogenization process, from 6 microns to 50 microns. It also shows a smaller particle size increase with the 1.5% Morwet™ concentration from 6 microns to 15 microns. This would suggest that at concentrations of or above 1.5% Morwet™, particle size growth will occur in the homogenization process.

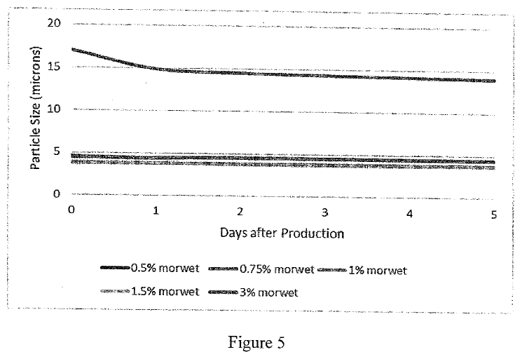

FIG. 5 shows the average mean percentile PSD (P50, μm) of 100 Hz micronized sulphur dispersion produced with various concentrations of Morwet™ over time (days), with fresh material and demineralized water. The final Morwet™ concentration was subsequently increased to 5.0% for all samples. No significant change in particle size was observed within 5 days of the increased surfactant addition.

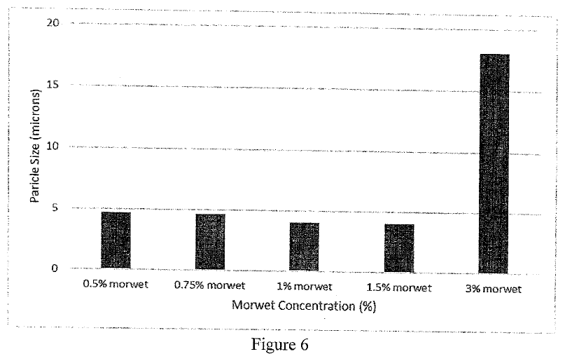

To determine if heat plays a significant role in sulphur dissolution, the 5% samples were all heated to 80° C. for two minutes and tested for particle size. FIG. 6 shows average mean percentile PSD (P50, μm) of the 5.0% Morwet™ samples after being heated to 80° C. FIG. 6 shows that the average particle sizes did not significantly increase over what is presented in FIG. 5. Dissolution at that temperature does not appear to occur within the time period presented.

### Example 3: Methods for the CMC of Micronized Sulphur Dispersion at Various Morwet™ Concentrations in Demineralized and Tap Water

The micronized sulphur dispersions that were tested and monitored were as follows:

| Surfactant Concentration (wt | |
|---|---|
| % Morwet ™) in dispersant | |
| solution | Water Type |
| 1% | demineralized |
| 1.5% | demineralized |
| 2% | demineralized |
| 3% | demineralized |
| 5% | demineralized |
| 1% | tap |
| 1.5% | tap |
| 2% | tap |
| 3% | tap |
| 5% | tap |

Fresh micronized sulphur dispersions were produced at 100 Hz with either demineralized or tap water at sulphur concentrations of approximately 60%. The samples were produced with various surfactant concentrations and were immediately collected and tested for PSD after production. The PSD were tested hourly or daily until particle sizes plateaued.

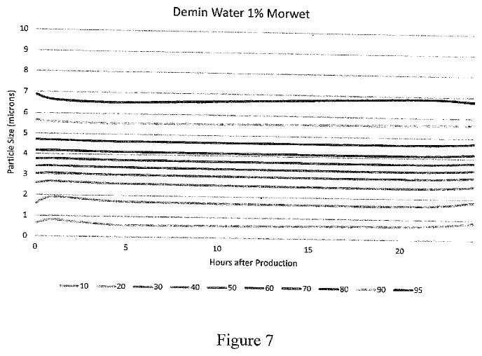

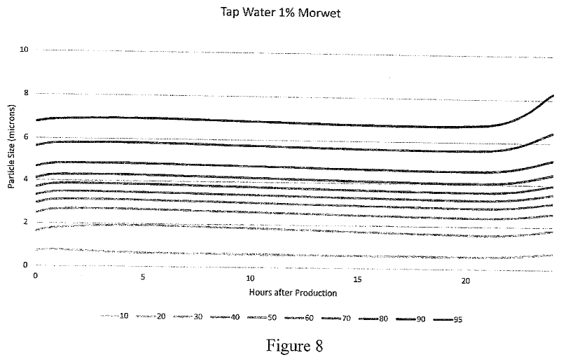

FIGS. 7 and 8 show the 10^{th} through 95^{th} particle size percentiles (microns) of the 100 Hz micronized sulphur dispersion produced with 1% Morwet™ over time (hrs) with either demineralized (FIG. 7) or tap water (FIG. 8).

Both FIG. 7 and FIG. 8 show that within the first 24 hours after production, no significant particle size increase is observed. For the tap water sample, a slight increase in the 95^{th} percentile was observed from 7 microns to 8 microns after 22 hours, but generally, the particle sizes did not increase in either demineralized or tap water, with 1% Morwet™.

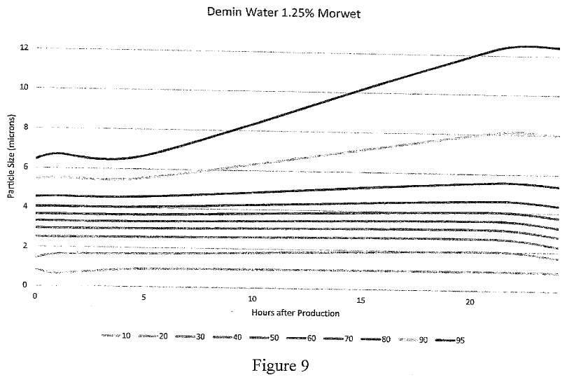

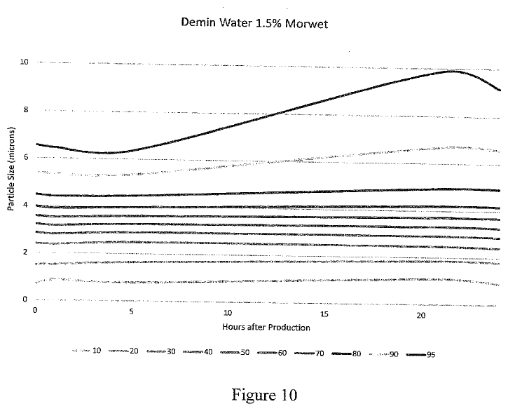

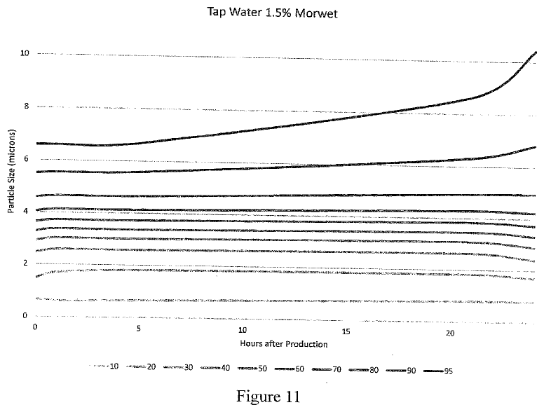

FIGS. 9-11 show the 10^{th} through 95^{th} particle size percentiles (microns) of the 100 Hz micronized sulphur dispersion produced with 1.25% Morwet™ (FIG. 9) over time (hrs) in demineralized water and with 1.5% Morwet™ over time (hrs) with either demineralized (FIG. 10) or tap water (FIG. 11).

FIG. 9 shows the upper 95^{th} percentile of particle size in the 1.25% Morwet™ after 5 hrs post-production increased from approximately 6 to 12 microns. The lower particle size percentiles did not change significantly in size suggesting that only the larger particles grew. It is proposed that during the homogenization process, elemental sulphur was solubilized and subsequently deposited on the larger particles. This would also indicate that the CMC for demineralized water is below 1.25% Morwet™.

FIG. 10 also shows that the upper 95^{th} percentile of particle size in the 1.5% Morwet™ and demineralized water sample after 5 hrs post-production increased in size from 6 to 9 microns, suggesting the larger particles are increased in size, whereas the smaller particles did not change significantly.

FIG. 11 shows that the upper 95^{th} percentile of particle size in the 1.5% Morwet™ and tap water sample after 5 hours post-production slightly increased in size from approximately 6.5 to 10.5 microns. The lower particle size percentiles did not change significantly in size and would therefore suggest that only the larger particles slightly increased in size.

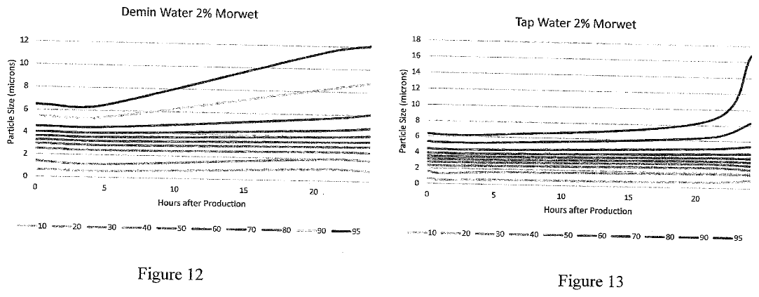

FIGS. 12 and 13 show the 10^{th} through 95^{th} particle size percentiles (microns) of the 100 Hz micronized sulphur dispersion produced with 2% Morwet™ over time (hrs) with either demineralized (FIG. 12) or tap water (FIG. 13).

FIG. 12 shows that the upper 80^{th}-95^{th} percentiles increased, with the 95^{th} percentile increasing from approximately 6 to 12 microns after 5 hrs post-production. This shows that the larger size particles were increasing in size but the smaller size particles remained relatively unchanged.

FIG. 13 shows that the upper 90^{th}-95^{th} percentiles increased in size, with the 95^{th} percentile increasing from 6 to 17 microns after 20 hours post-production. No significant change was noted with the smaller sized particles.

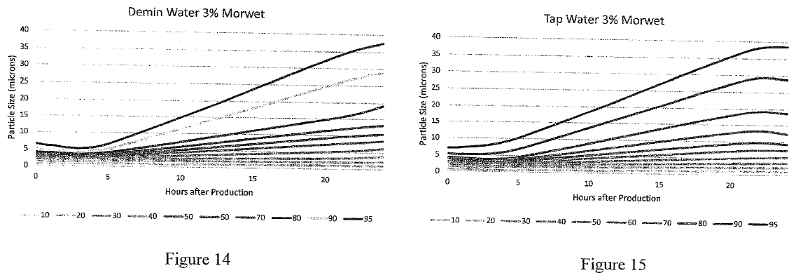

FIGS. 14 and 15 show the 10^{th} through 95^{th} particle size percentiles (microns) of the 100 Hz micronized sulphur dispersion produced with 3% Morwet™ over time (hrs) with either demineralized (FIG. 14) or tap water (FIG. 15).

FIG. 14 shows that the 40^{th}-95^{th} particle size percentiles (microns) increased in size after 5 hours post-production. The average (50^{th} percentile) particle size increased from approximately 3 to 6 microns whereas the upper 95^{th} percentile increased from approximately 6 to 38 microns.

FIG. 15 shows that the 40^{th}-95^{th} particle size percentiles (microns) also increased in size after 5 hours post-production. The average (50^{th} percentile) particle size increased from 3 to 7 microns and the upper 95^{th} percentile increased from 7 to 38 microns. This would indicate that that the CMC is below 3% Morwet™ in tap water.

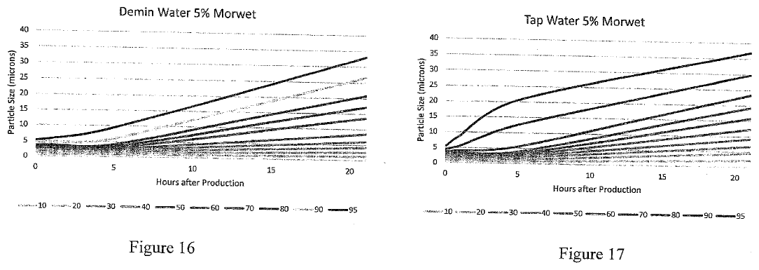

FIGS. 16 and 17 show the 10^{th} through 95^{th} particle size percentiles (microns) of the 100 Hz micronized sulphur dispersion produced with 5% Morwet™ over time (hrs) with either demineralized (FIG. 16) or tap water (FIG. 17).

FIG. 16 shows that the 30^{th}-95^{th} particle size (microns) percentiles increased significantly in size after 5 hours post-production, with the 95^{th} percentile increasing almost immediately after production. The average (50^{th} percentile) particle size increased from approximately 2.5 to 8 microns, whereas the 95^{th} percentile increased from 6 to 33 microns.

FIG. 17 shows the 10^{th}-95^{th} particle sizes (microns) percentiles to have increased significantly in size after 5 hours post-production, where the 90^{th} and 95^{th} percentiles increased immediately after production. The lower 10^{th} particle size percentile increased from approximately 0.7 microns to 2 microns, the average (50^{th} percentile) increased approximately from 2.6 microns to 12 microns, and the upper 95^{th} percentile increased from approximately 5 microns to 37 microns.

The observed changes in particle size would suggest that for demineralized water samples containing below 1.25% Morwet™, the particle sizes did not change significantly. Between 1.25% Morwet™ and 3% Morwet™, only the upper particle size percentile changed in size. Above 3% Morwet™, most particle size percentiles increased significantly in size. For tap water, a slight increase in particle size in the upper particle size percentiles were observed between 1.5% and 3% Morwet™, but no significant change for the average or lower particle size percentiles were observed. At 3% Morwet™ and above, significant particle size changes were observed for all particle size percentiles. This would suggest that the CMC for demineralized water is between 1% and 1.25% Morwet™, and for tap water it is between 2% and 3% Morwet™. At these Morwet™ concentrations, significant sulphur dissolution occurs during the homogenization process and causes significant particle growth upon cooling.

### Example 4—Methods for the PSD of Micronized Sulphur Dispersion Over Time with 1.5% or 5.0% Morwet™ in a Stirred or Settled State

The micronized sulphur dispersions that were tested and monitored were prepared as follows:
1. 1.5% Morwet™+demineralized water
2. 5% Morwet™+demineralized water

Liquid micronized sulphur dispersion was produced at 100 Hz at approximately 65% sulphur and sampled into jars. One sample was kept in suspension by continuously stirring with a stir bar, and the other sample was left to settle. The PSD of both samples were measured daily for 7 days, and weekly thereafter for 4 weeks.

At day 4, 100 g of both stirred and settled samples were transferred to a new jar and Morwet™ powder was added to a final Morwet™ concentration of 5%. The 5% Morwet™ samples were kept at the same conditions as above and measured daily for one week and weekly for one month. All measurements are the averages of three replicates, with standard error bars.

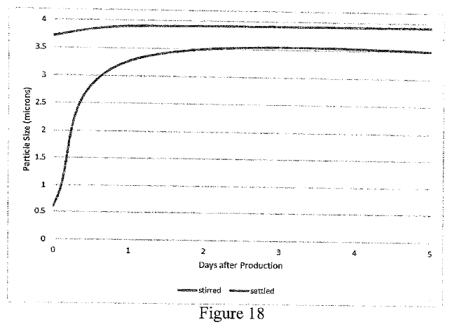

FIG. 18 shows the PSD P50 of the samples where the Morwet™ concentration was not modified. It appears that stirring the sample delayed growth of the particles. Between Day 0 and Day 1, the stirred sample increased in size from 0.5 to 3 microns whereas the settled sample increased immediately after production to 3.5 microns (Day 0). This would suggest that stirring after production delays the deposition of dissolved sulphur on the existing particles, thus delaying particle growth.

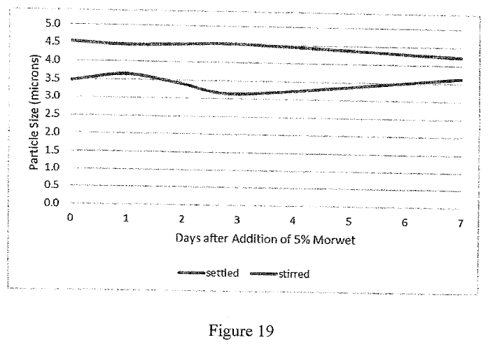

FIG. 19 shows the average mean percentile PSD (P50, μm) for those samples where additional Morwet™ was added (at Day 4) to the treatments to achieve a total concentration of 5.0%. With additional surfactant added, no significant change in particle size was observed.

### Example 5: Methods for the CMC of Micronized Sulphur Dispersion at Various Triton X-405™ Concentrations in ap Water

The micronized sulphur dispersions that were tested and monitored were as follows:

| Surfactant Concentration (wt | |
|---|---|
| % Triton X-405 ™) in | |
| dispersant solution | Water Type |
| 1% | tap |
| 1.5% | tap |
| 2% | tap |
| 5% | tap |

Fresh micronized sulphur dispersions were produced at 100 Hz with tap water at sulphur concentrations of approximately 60%. The samples were produced with various surfactant concentrations and were immediately collected and tested for PSD after production. The PSD were tested hourly or daily until particle sizes plateaued.

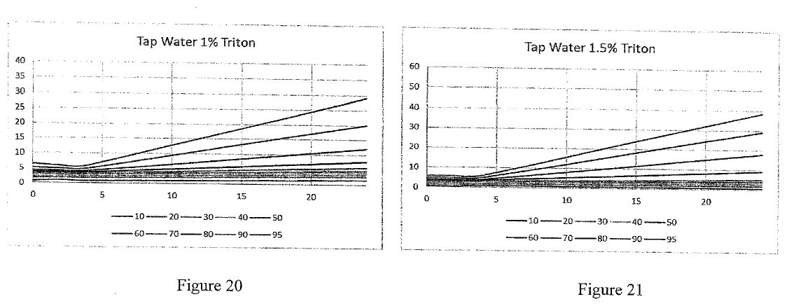

FIGS. 20 to 24 show the 10^{th} through 95^{th} particle size percentiles (microns) of the 100 Hz micronized sulphur dispersion produced with 1%, 1.5%, 2%, and 5% Triton X-405™ over time (hrs) with tap water.

FIG. 20 shows that the 80^{th}-95^{th} particle size percentiles (microns) increased in size, with the 95^{th} percentile increasing from 6 to 30 microns after 24 hours post-production and the 80^{th} percentile increasing from 5 to 13 microns. No significant change was noted with the smaller sized particles. This appears to indicate that that the CMC is below 1% Triton X-405™ in tap water.

FIG. 21 shows that the 70^{th}-95^{th} particle size percentiles (microns) increased in size. The 70^{th} percentile particle size increased from 3 to 9 microns and the upper 95^{th} percentile increased from 6 to 40 microns.

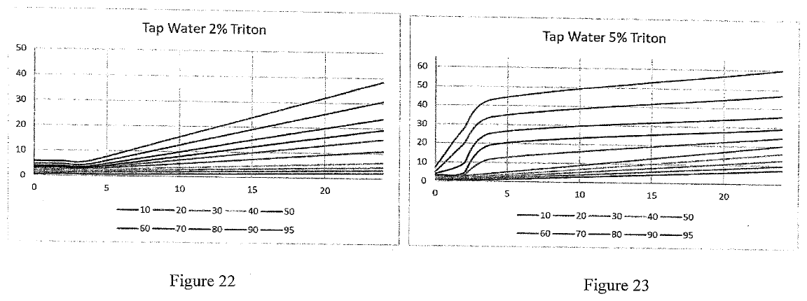

FIG. 22 shows that the 50^{th}-95^{th} percentiles increased in size, with the 95^{th} percentile increasing from 5 to 40 microns and the average (50^{th} percentile) increasing from 3 to 11 microns.

FIG. 23 shows that the 10^{th}-95^{th} particle size percentiles increased in size. The 10^{th} percentile particle size increased from under 1 micron to 7 microns and the upper 95^{th} percentile increased from 7 to 60 microns.

The observed changes in particle size would suggest that for tap water samples containing below 1.5% Triton X405™, the particle sizes did not change significantly below the 80^{th} percentile. Between 1% Triton X405™ and 2% Triton X405™, only the upper particle size percentiles increased in size. Above 2% Triton X405™, most particle size percentiles increased significantly in size. This would suggest that the CMC for tap water is below 1% Triton X405™. As would be expected, the CMC for Triton X405™ in demineralized water should be lower than in tap water.

Interpretation

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited value or range that are equivalent in terms of the functionality of the composition, or the embodiment.

[102] As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

[103] As will also be understood by one skilled in the art, all language such as “between”, “up to”, “at least”, “greater than”, “less than”, “more than”, “or more”, and the like, include the number(s) recited and such terms refer to ranges that can be subsequently broken down into sub-ranges as discussed above. In the same manner, all ratios recited herein also include all sub-ratios falling within the broader ratio.

1. A method of producing micronized sulphur, comprising the steps of:
(a) preparing an emulsion of liquid sulphur in an aqueous dispersant solution comprising a surfactant in a concentration below 1.5% (wt.) and below its critical micelle concentration (CMC); and
(b) solidifying the liquid sulphur droplets to produce a micronized sulphur suspension.

2. The method of claim 1, wherein the quantity of surfactant is optimized by measuring the CMC in the solution and determining an optimum concentration of surfactant which minimizes particle size and/or particle size variation.

3. The method of claim 1, wherein the concentration of surfactant is less than about 75%, 50%, 40%, 30% or 20% of its CMC.

4. The method of claim 1, wherein the surfactant comprises an anionic surfactant or a nonionic surfactant.

5. The method of claim 4 wherein the surfactant comprises naphthalene sulphonate or octylphenol ethoxylate.

6. The method of claim 1, wherein the surfactant concentration is less than about 0.75% (wt.).

7. The method of any one of claims 1 to 6, wherein the dispersant solution is made up with demineralized water.

8. The method of any one of claims 1-7, comprising the further step of periodically stirring the suspension of solid micronized sulphur.

9. A micronized sulphur product having a mean or median particle size of about 5 microns or less, or preferably about 3 microns of less.

10. The micronized sulphur product of claim 9 wherein 95% of the particles are less than 12, 10, 9, or 8 microns.

11. A micronized sulphur product, dispersed in solution comprising an aqueous dispersant comprising a surfactant in a concentration below 1.5% (wt.) and below its critical micelle concentration (CMC).

12. The product of claim 11, wherein the mean or median particle size is less than about 5 microns in size, or less than about 3 microns in size, and which mean or median particle size does not substantially increase over 24 hours, 2, 3, 4, 5, 6 , 7 or 30 days.

13. The product of claim 11, wherein the mean or median particle size of the particles smaller than the 50th, 60th, 70th, 80th, 90th or 95th percentile does not substantially increase over time.

14. The product of claim 11, further comprising a fertilizer salt, such as urea ammonium nitrate (UAN), ammonium sulphate, ammonium polyphosphate (APP).

15. The product of claim 11, further comprising a herbicide, pesticide or fungicide.

16. The product of claim 11 further comprising a suspension agent, such as a polysaccharide, such as a substituted or unsubstituted starch, pectate, alginate, carageenate, gum arabic, guar gum and xanthan gum, or a clay.

17. The product of claim 11 wherein the solution does not comprise solubilized sulphur.
